(19) United States
(12) Patent Application Publication
(10) Pub. No.: US 2010/0125567 A1
(43) Pub. Date: May 20, 2010

(54) Method and System for managing Metadata associated with a resource

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 12/273,003

(22) Filed: Nov. 18, 2008

(51) Int. Cl. G06F 17/30; G06F 7/00

(52) U.S. Cl. 707/722; 707/E17.005; 707/E17.044

(57) ABSTRACT

Methods, systems and computer program products are described for processing a media stream. In one aspect, a method and a computer readable medium containing a computer program, executable by a machine, for managing metadata associated with a resource includes and comprises executable instructions for accessing a network resource, and identifying metadata associated with the resource in response to accessing the resource. In one embodiment, the metadata is specified according to an identified schema. In response to identifying the metadata, a message is generated identifying the resource, the metadata, and the identified schema. The message is sent to a metadata repository service configured to maintain a metadata association between the identified metadata and the resource.

### COPYRIGHT NOTICE

A portion of the disclosure of this patent document contains material which is subject to copyright protection. The copyright owner has no objection to the facsimile reproduction by anyone of the Patent and Trademark Office patent file or records, but otherwise reserves all copyright rights whatsoever.

### BACKGROUND

Most web accessible resources are associated with a schema defining one or more of a resource's format, structure, vocabulary, and/or semantics. HTTP, for example, has a schema defined by the World Wide Web Consortium (W3C) specifying, among other things, valid tags, the structure of valid HTTP documents, and attributes associated with tags. In fact, HTTP documents and most other markup based resources, e.g., XML based resources, can include the schema for the resource and/or a reference to the schema in the resource. Alternatively, the schema can be provided with the resource. Non-text resources, such as images, can also have schemas, such as EXIF and TIFF, defining their format and content. Similarly, other media types including executable media types, such as Javascript resources and/or Java resources, can have schemas defining their format and content.

In some cases, a resource can include data that is related to the information in the resource. Such data is typically referred to as metadata. For example, metadata related to a digital image can describe the capture settings for the image, and metadata related to a digital music file can be a song title and artist name. Metadata can be included in a resource, and/or can be included in or can be a separate resource from the resource to which the metadata is related.

In some resources, data can be explicitly identified as metadata. For example, a <meta> tag in an HTML document identifies the data included in the tag as metadata for the including HTML document. The following exemplary use of a <meta> element identifies an author of a document that includes and/or references the element.

<meta name=“author” content=“John Jones”/>

EXIF files include tag locations for storing metadata associated with an image included in an EXIF file. In other situations, whether data is metadata with respect to a resource, or a portion of the resource, is configurable and subject to perspective and judgment. Thus, a picture in a web page with descriptive text can be considered metadata for the text. Alternatively, the text can be considered metadata for the picture. Finally, both can be considered metadata for some other resource. When data is defined to be and/or is used as metadata with respect to a resource, it is metadata.

Metadata systems abound. Nonetheless, the collection and location of metadata has been and remains a long-standing problem. For instance, metadata collection is difficult because such collection typically requires human data entry. Moreover, even if collected, the locating of collected metadata is difficult because few accessible repositories, beyond standard web search engines, exist. Furthermore, existing instances of metadata are scattered throughout the Internet and although they can be detected by a variety of programs, those programs do not and/or cannot communicate with each other.

### SUMMARY

Methods, systems and computer program products are described for managing metadata associated with a resource. The methods, systems, and computer program products allow an association between identified metadata and a resource to which it is related to be maintained in a metadata repository service (MRS). The MRS can be useful for searching, and can also provide a rich platform for automating the web and making the web “machine” friendly. In one aspect, a method and a computer readable medium storing a computer program, executable by a machine, for managing metadata associated with a resource includes and comprises executable instructions for accessing a network resource, and identifying metadata associated with the resource in response to accessing the resource. In one embodiment, the metadata is specified according to an identified schema. In response to identifying the metadata, a message is generated identifying the resource, the metadata, and the identified schema. The message is sent to a metadata repository service configured for maintaining a metadata association between the identified metadata and the resource.

In another aspect of the subject matter disclosed herein, a method and a computer readable medium storing a computer program, executable by a machine, for managing metadata associated with a resource includes and comprises executable instructions for receiving, by a metadata repository service for a first metadata domain, a message identifying metadata associated with an identified resource, and an identifier of a schema for the metadata, and determining, based on the schema identifier, a second metadata domain associated with the metadata. The method further includes determining whether the second metadata domain is included in the first metadata domain, and storing an association between the metadata and the identified resource when the second metadata domain is determined to be included in the first metadata domain.

In another aspect of the subject matter disclosed herein, a system for managing metadata associated with a resource includes a content receiver configured to access a network resource, a data modeler component configured to identify metadata associated with the resource in response to accessing the resource, the metadata specified according to an identified schema, a command handler configured to generate, in response to identifying the metadata, a message identifying the resource, the metadata, and the identified schema, and a message formatter component configured to send the message to a metadata repository service configured to maintain a metadata association between the identified metadata and the resource.

In another aspect of the subject matter disclosed herein, a system for managing metadata associated with a resource includes a content receiver in a metadata repository service for a first metadata domain configured to receive a message identifying of metadata associated with an identified resource, and an identifier of a schema for the metadata, a command handler component configured to determine, based on the schema identifier, a second metadata domain associated with the metadata, a resolver component configured to determine whether the second metadata domain is included in the first metadata domain, and a repository manager component configured to store an association between the metadata and the identified resource when the second metadata domain is determined to be included in the first metadata domain.

### BRIEF DESCRIPTION OF THE DRAWINGS

Advantages of the subject matter claimed will become apparent to those skilled in the art upon reading this description in conjunction with the accompanying drawings, in which like reference numerals have been used to designate like elements, and in which:

FIG. 1 is a flow diagram illustrating a method for managing metadata associated with a resource according to an exemplary embodiment;

FIG. 2 is a block diagram illustrating a system for managing metadata associated with a resource according to an exemplary embodiment;

FIG. 3 is a block diagram illustrating another system for managing metadata associated with a resource according to another exemplary embodiment;

FIG. 4 is a block diagram illustrating another system for managing metadata associated with a resource according to yet another exemplary embodiment;

FIG. 5 illustrates a network in which a system for managing metadata associated with a resource can be implemented;

FIG. 6 illustrates another network in which a system for managing metadata associated with a resource can be implemented;

FIG. 7 is a flow diagram illustrating another method for managing metadata associated with a resource according to another exemplary embodiment;

FIG. 8 is a block diagram illustrating a system for performing the method of FIG. 7 according to an exemplary embodiment; and

FIG. 9 is a block diagram illustrating a system for managing metadata associated with a resource according to another exemplary embodiment.

### DETAILED DESCRIPTION

The subject matter presented herein allows an association between identified metadata and a resource to which it is related to be maintained in a metadata repository service (MRS). The MRS can be useful for searching, and can also provide a rich platform for automating the web and making the web “machine” friendly. Various aspects will now be described in connection with exemplary embodiments, including certain aspects described in terms of sequences of actions that can be performed by elements of a computing device or system. For example, it will be recognized that in each of the embodiments, at least some of the various actions can be performed by specialized circuits or circuitry (e.g., discrete and/or integrated logic gates interconnected to perform a specialized function), by program instructions being executed by one or more processors, or by a combination of both. Thus, the various aspects can be embodied in many different forms, and all such forms are contemplated to be within the scope of what is described.

According to one embodiment, metadata can be and typically is specified according to a particular schema. One or more schema languages can specify the metadata schema, such as specification languages XML schema, RDF schema, and data type definition (DTD), to name a few. Each instance of metadata can be specified according to its schema. Because a schema specifies format, structure, and/or vocabulary, as well as semantics, an instance of metadata can be represented in a patterned manner. A schema, whether for a markup language, a media file, an executable resource, or metadata, can be identified by a Uniform Resource Identifier (URI) and/or some other type of identifier.

In an exemplary embodiment, a URI determined for an identified metadata can be associated with a metadata repository service (MRS) that is configured to maintain a metadata association between the identified metadata and a resource to which the metadata is related. The metadata's schema can be identified as well and can be included in the association. In one embodiment, the MRS can be associated with a schema and can be configured to accept and store as records instances of metadata that are specified according to the associated schema. In one embodiment, the MRS having the schema can determine whether a metadata instance is valid according to the schema. Alternatively or additionally, the MRS can store a reference to metadata stored elsewhere.

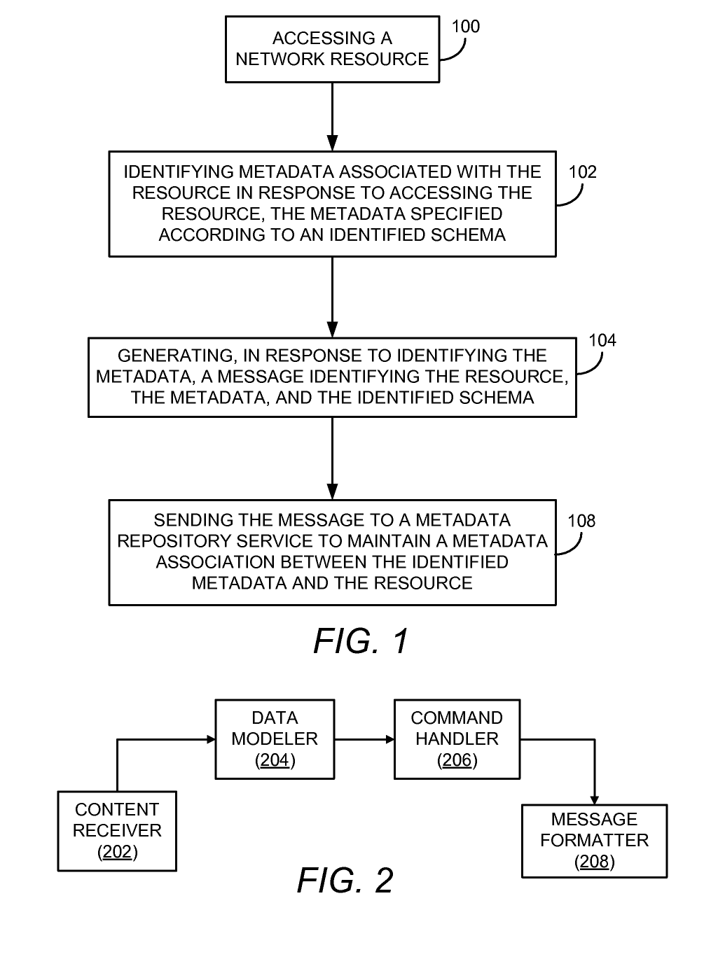

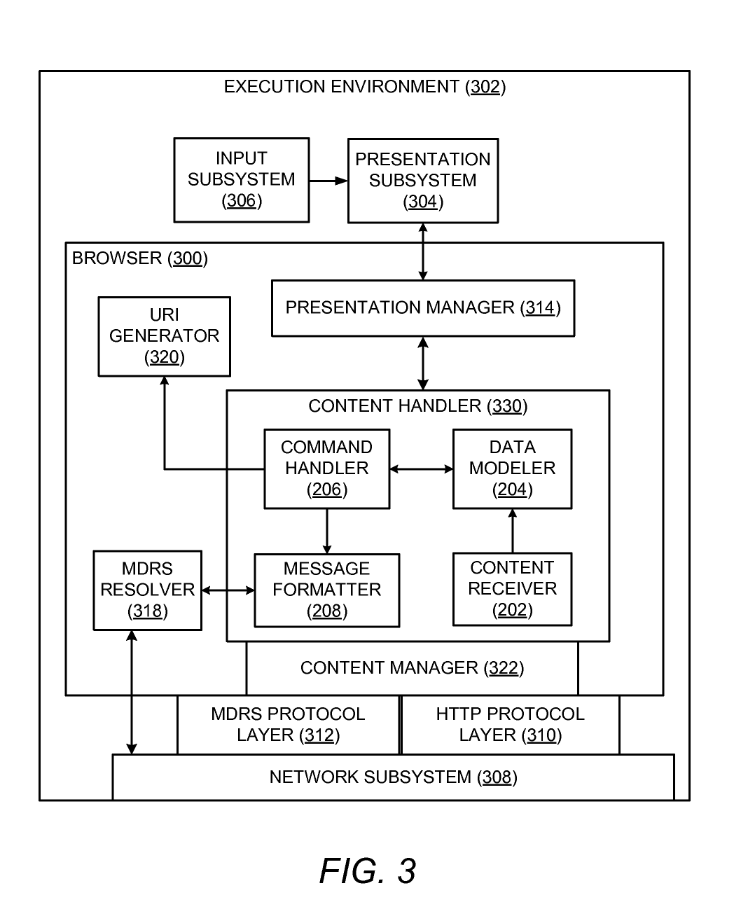

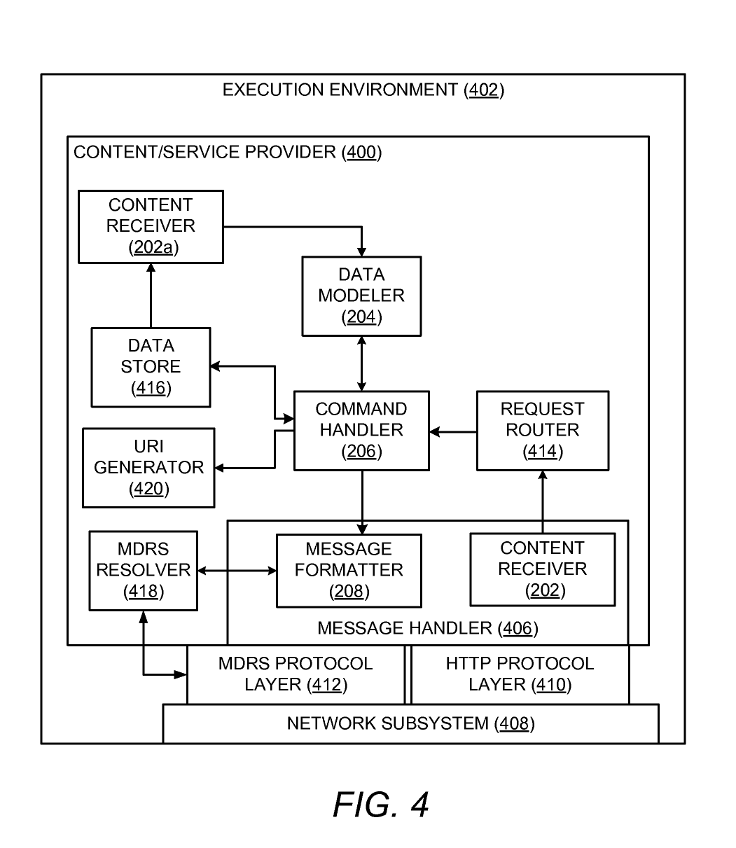

FIG. 1 is a flow diagram illustrating a method for managing metadata associated with a resource according to an exemplary embodiment. FIGS. 2, 3, and 4 are block diagrams illustrating systems for managing metadata associated with a resource according to embodiments of the subject matter described herein. In particular, FIG. 2 illustrates an arrangement of components configured for managing metadata associated with a resource, while FIG. 3 and FIG. 4 illustrate the components of FIG. 2 and/or their analogs adapted for operation in execution environments provided by nodes for managing metadata associated with a resource. The method illustrated in FIG. 1 can be carried out by, for example, at least some of the components in each of the exemplary arrangements of components illustrated in FIGS. 2, 3, and 4.

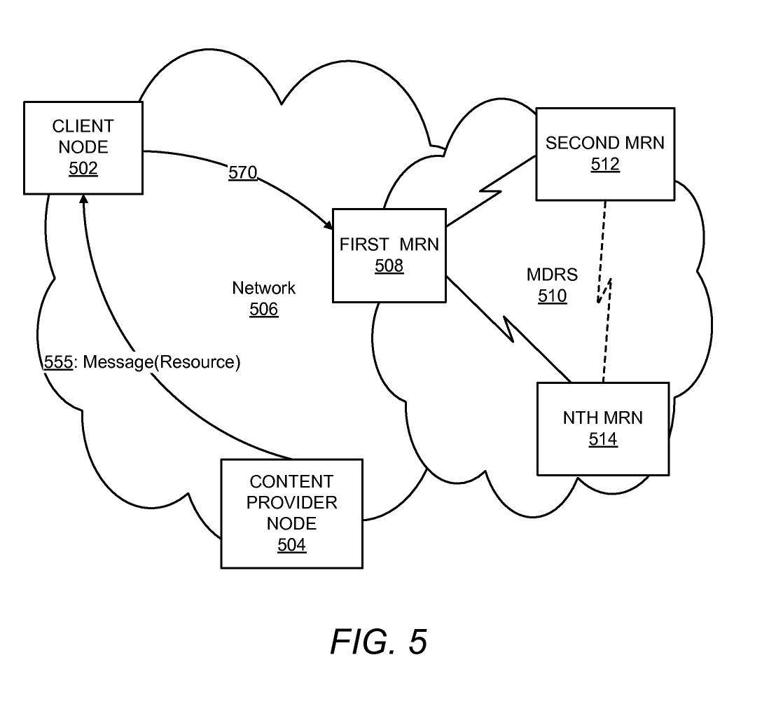

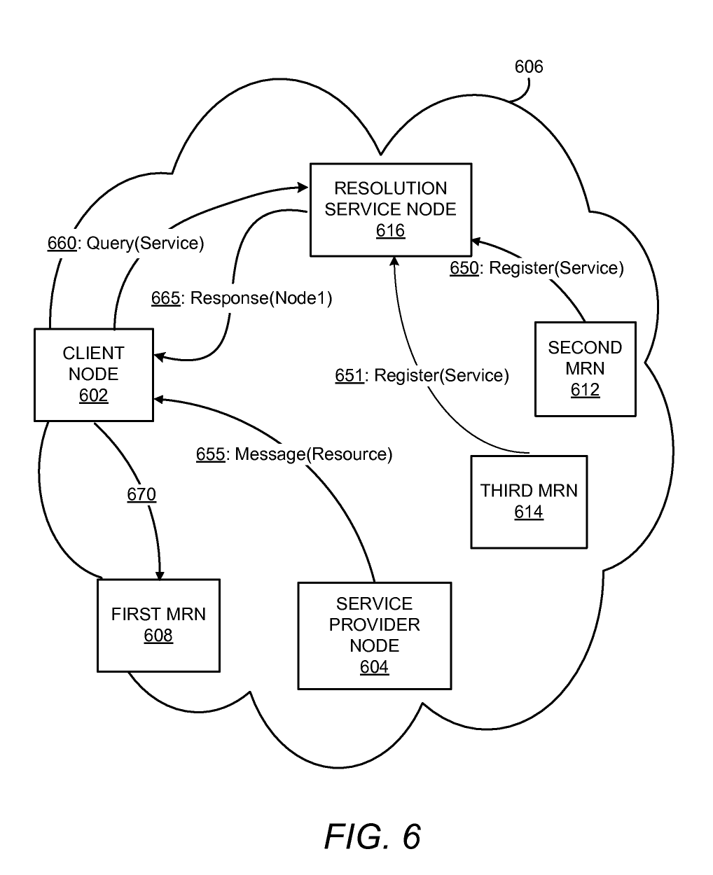

FIG. 2 illustrates components that are configured to operate within an execution environment hosted by a node and/or multiple nodes, as in a distributed execution environment. For example, in FIG. 5 and FIG. 6, which each illustrate a plurality of nodes communicatively coupled to one another via a network 506, 606 such as the Internet, client nodes 502, 602, content provider nodes 504, and service provider nodes 604 can be configured to provide respective execution environments configured to support the operation of the components illustrated in FIG. 2 and/or their analogs. Exemplary nodes can include desktop computers, servers, networking nodes, notebook computers, PDAs, mobile phones, and digital image capture devices.

An exemplary execution environment can include a memory for storing components and an instruction processing component, such as processor and/or a digital signal processor (DSP), for processing instructions and any data associated with the operation of the components illustrated in FIG. 2. The components illustrated in FIG. 2, and functionally analogous components, each can require additional hardware and/or software subsystems according to their particular operational requirements. For example, a network subsystem can be included in the execution environment for enabling communication between nodes over the network 506, 606. An operating system, a persistent data storage subsystem, a memory management subsystem, and/or a process scheduler are other examples of components that can be required for various adaptations of the components illustrated in FIG. 2 and their functional analogs for performing the method in FIG. 1.

Illustrated in FIG. 3 is a browser 300 including the components illustrated in FIG. 2 adapted for operating in an execution environment 302. The execution environment 302, or an analog, can be provided by a node such as the client node 502, 602. Alternatively or in addition, as illustrated in FIG. 4, the components illustrated in FIG. 2 can be adapted for operation in a content/service provider 400 in an execution environment 402 provided by a content 504 and/or service 604 provider node.

With reference to FIG. 1 in block 100, a network resource is accessed. In one embodiment, a system for managing metadata associated with a resource includes means for accessing a network resource. For example, FIG. 2 illustrates a content receiver 202 configured to access the network resource.

According to an exemplary embodiment, the content receiver 202 can access the network resource by receiving the resource, e.g., a webpage, over a network in a message and/or retrieving the resource from a local source. For example, the received message can be a response to a request, a notification associated with a subscription, and/or an unsolicited asynchronous message. Alternatively or additionally, the content receiver 202 can access a local resource such as a file that is accessible via a “file://” schema and/or a database record via a database Uniform Resource Name (URN) scheme.

According to one embodiment, the components illustrated in FIG. 2, including the content receiver 202, can be adapted to operate in a browser 300 in an execution environment 302 provided by a node, such as the client node, e.g., 502, 602. In one embodiment, the content receiver 202 can be included in a content handler component 330 configured for processing a particular type, e.g., MIME type, of content for presentation. The browser 300 can include at least one content handler 330 to process different data types. For example, a video stream content handler 330 can be provided and configured to process a particular type of video data corresponding to a video stream. Alternatively, image content handlers 330 can be provided and configured to process image data formats identifiable by MIME type. Additionally or alternatively, a content handler 330 configured to process one or more types of markup language based data can be provided.

In another embodiment, the components illustrated in FIG. 2 for managing metadata associated with a resource can also be adapted for operation within a content 504 and/or a service 604 provider node, shown in FIG. 5 and FIG. 6, respectively, that provides an execution environment 402 hosting a content/service provider service 400. In particular, the service 400 can include a message handler 406 that has a content receiver 202 configured to access the network resource.

The message handler 406 in a web application platform typically manages incoming messages and outgoing messages. In one embodiment, an incoming message can include a request to GET or FETCH a resource stored in a local data store 416. Alternatively, the incoming message can include a request to POST or store a resource in the local data store 416. The outgoing message can be a response to the GET request, a notification message and/or an asynchronous unsolicited message. The outgoing message can include a resource retrieved from the local data store 416.

In one embodiment, the content receiver 202 in the message handler 406 can be configured to receive and to parse an incoming message, e.g., an HTTP message, to extract its contents, which can be in multiple parts and can be formatted as different types. That is, different portions of the content can have different schemas. The content receiver 202 can provide access to information in a message header to other components of the content/service provider 400. For example, the content receiver 202 can pass a request to a request router 414 that is configured to route the request to a suitable command handler 206 configured to process the request, e.g., for storing or for retrieving the requested resource in or from the local data store 416.

In the browser 300 and in the content/service provider 400, the network resource can be accessed as incoming data, e.g., when the browser 300 receives the resource in response to a request or when the content/service provider 400 receives the resource in a POST message. Additionally, in the content/service provider 400, the network resource can be accessed as outgoing data, e.g., when the content/service provider 400 provides the resource to a requesting entity. When the resource is accessed as outgoing data, a content receiver 202a associated with the local data store 416 can be provided to receive the retrieved resource. In one embodiment, the resource can be received via and/or in response to an invocation of the content receiver component 202a by another component operating in the execution environment 402, via an interprocess communication mechanism such as a pipe or queue. Alternatively, the resource can be retrieved in response to an event such as timer pop. In another embodiment, a command handler component 206 can be configured to access the network resource as outgoing data in the content/service provider 400 as well as in the browser 300, e.g., in a POST command.

In one embodiment, when the resource is accessed as incoming data, it can be received as a message transmitted over a network 506, 606 by the client nodes 502, 602 and/or the provider nodes 504, 604. For example, in FIG. 5, a message 555 from the content provider node 504 is received by the client node 502, and in FIG. 6, a message 655 from the service provider node 604 is received by the client node 602. In these cases, the incoming messages can be received by the content receiver 202 via a network subsystem 308, 408. In one embodiment, the content receiver 202 can receive the message directly via a protocol layer of the network subsystem 308, 408 or via an application layer protocol, or other higher layer protocol, as illustrated by an exemplary HTTP protocol layer 310, 410 among many possible standard and proprietary protocol layers. For example, the content receiver 202 can receive the message via an application protocol layer supporting a protocol specifically for communicating with and/or within a Metadata Repository System (MDRS).

In one embodiment, an MDRS 510 includes at least one metadata repository node MRN 508, 512, 514 and can be a centralized network, as illustrated in FIG. 5, or distributed across MRNs 608, 612, 614, as illustrated in FIG. 6, or a combination thereof. An MDRS protocol layer 312, 412 can be provided and configured to enable the content receiver 202 to communicate with one or more MRNs, e.g., 508, where an MDRS protocol is defined for the purpose of communicating with the MRN 508. These higher protocol layers can encode, package, and/or reformat resource data for sending and receiving in messages over a network layer such as an IP and/or a transport layer such as TCP and/or UDP.

In the browser 300, the content receiver 202 can access at least a portion of the resource included in a received message, or in a message to be sent, and parse the message into elements of the type(s) supported by the content handler 306. In the content/service provider 400, the content receiver 202 can access at least a portion of the resource included in a received message, or in a message to be sent, and separate the message into message portions, such as a message header and content portions, when content is present.

Referring again to FIG. 1 in block 102, metadata associated with the resource is identified in response to accessing the resource. In one embodiment, the metadata is specified according to an identified schema. A system for managing metadata associated with a resource includes means for identifying metadata associated with the resource in response to accessing the resource, the metadata specified according to an identified schema. For example, FIG. 2 illustrates a data modeler component 204 configured to identify metadata associated with the resource in response to accessing the resource, the metadata specified according to an identified schema.

According to one embodiment, the data modeler component 204 is configured to receive accessed resource data from the content receiver 202 and to identify metadata associated with the resource. In one embodiment, the metadata can be included in the resource, in a message including at least a portion of the resource, received in another message, and/or retrieved from another source, such as a file in a data store or a record in a database.

The metadata, in one embodiment, can be specified according to an identified schema and can be validated as such. Exemplary metadata schemas include a schema for the Dublin Core, as defined in 2003 by ISO Standard 15836 and NISO Standard Z39.85-2007, a resource definition framework (RDF) specified by the W3C, an RDF Schema (RDFS) published by The W3C, an exchangeable image file format (EXIF), a standard of the Japan Electronics and Information Technology Industries (JEITA), and numerous others. The metadata schema need not be defined specifically for metadata, nor must it be a markup language schema (XML). The schema can specify a format, vocabulary, structure, and/or semantics for valid metadata, which can be any type of data, e.g., text and/or binary.

According to one embodiment in the browser 300, the data modeler component 204 can be included in the content handler 330 processing the resource, or a portion thereof. The content handler 330 processing the resource can be the same or a different content handler 330 processing metadata identified as associated with the resource. Analogously, a schema for specifying a resource, or a portion thereof, can be the same and/or a different schema specifying the identified metadata associated with the resource.

The data modeler component 204 in the content handler 330 can be configured to receive the accessed resource data from the content receiver 202, and to assemble a data model, such as a document object model (DOM) for HTML and other XML variants, corresponding to the network resource. Alternatively, the data modeler component 204 can receive accessed resource data from the content receiver 202 and process the data dynamically as it is received, e.g., as is the case with a simple API for an XML (SAX) parser. Each data type and corresponding content handler 330 can be associated with a schema for parsing and modeling data of a particular type. Thus a schema of a resource can be identified based on a MIME type of the resource.

In one embodiment, to identify metadata associated the accessed resource, the data modeler component 204 can be configured to detect particular types of relationships based on any accessible information associated with a resource. For example, with respect to an image presented in a web page, a portion of the web page can be identified as metadata for the image, such as a Uniform Resource Locator (URL) for the image, a data type for the image, a title for the image, and/or a description of the image. Alternatively, in some cases, the image presented in the web page can be identified as metadata for a portion of the web page. For example, when the page includes a description of a process and the image provides a picture of the creator of the process, the image can be identified as metadata for the described process according to the configuration of the node processing the accessed resource.

According to one embodiment, the data modeler component 204 can be configured to detect these relationships based on its configuration. For example, a resource that references a second resource can be identified as metadata for the second resource and/or vice versa. In addition, data specified according to a schema defined for specifying metadata can be identified as metadata and associated with an accessed resource based on a resource identifier in the metadata, a metadata identifier in a link, and/or receiving the metadata along with the resource.

In another embodiment, the data modeler component 204 can be included in the content/service provider service 400, as illustrated in FIG. 4. In this embodiment, the data modeler component 204 can receive the accessed resource data from the content receiver 202 via the command handler 206, e.g., when the resource is included in an incoming message, or directly from the content receiver 202a associated with the data store 416 or from the command handler 206, e.g., when the resource is to be included in an outgoing message.

In one embodiment, the content receiver 202 in the message handler 406 can be configured to provide a request identifier, such as a portion of a URL path in an HTTP request header, to the request router 414. The request router 414 can be configured to provide access to portions of the received message and any included content, as provided by the content receiver 202 interoperating with the message handler 406, to one or more command handlers 206 based on the request identifier. For example, the request can be a request for a web page and/or a media object received via an HTTP message. Alternatively, the request can be a subscribe or a publish message received from a publish-subscribe client such as a presence protocol watcher or presentity. A command handler 206 can be configured to process various portions of the message and/or content (if any) according to the request it is configured to process. In processing a request, data of various types can be provided to one or more data modeler components 204 corresponding to the type of the data.

Similar to the data modeler component 204 in the browser 300 described above, the data modeler component 204 in the content/service provider 400 can be configured to receive the accessed resource data and to assemble a data model, such as a document object model (DOM) for HTML and other XML variants, corresponding to the network resource. Alternatively, the data modeler component 204 can receive accessed resource data and process the data dynamically as it is received. In this manner, metadata associated with the resource can be identified in response to accessing the network resource.

Referring again to FIG. 1 in block 104, in response to identifying the metadata, a message is generated identifying the resource, the metadata, and the identified schema. A system for managing metadata associated with a resource includes means for generating, in response to identifying the metadata, a message identifying the resource, the metadata, and the identified schema. For example, FIG. 2 illustrates a command handler 206 configured to generate a message identifying the resource, the metadata, and the identified schema in response to identifying the metadata.

According to one embodiment, each content handler 330 in the browser 300 can support one or more command handlers 206 for processing one or more command types. Some command handlers 206 can be configured to present content on an output device through a presentation manager 314 configured to coordinate resource presentation for the browser 300. The presentation manager 314 can be configured to interoperate with a presentation subsystem 304 operatively coupled to one or more presentation devices (not shown). One or more command handlers 206 can be provided by the browser 300 to respond to inputs typically received in correspondence with the presentation of an accessed resource. An input can be detected by an input subsystem 306 via an input device (not shown). The input can be provided to the presentation subsystem 304, which can identify an application and/or a portion thereof corresponding to a portion of a presentation to associate with the input.

Based on the identified association, the presentation subsystem 304 can be configured to provide input information, including presentation information such as display coordinates, to the corresponding application and/or portion thereof. The application and/or a portion thereof, such as a widget handler managed by the presentation manger 314, can invoke, and/or can be, one or more command handlers 206. The command handler 206 can be external to the widget handler, included in the widget handler, and/or be the widget handler.

When metadata associated with the accessed resource is identified, the data modeler component 204 can invoke the command handler 206 configured to generate a message identifying the resource, the metadata, and the identified schema of the metadata. Alternatively or additionally, the command handler 206 can be invoked by the widget handler in response to receiving a user input, an event and/or an indication received from another component in the execution environment 302.

According to another embodiment, the content/service provider 400 can include one or more command handlers 206 configured to process commands, such as requests for accessing resources, e.g., a request for a web page, requests to access an account to update account information, and requests to generate a notification and/or unsolicited asynchronous message. For example, updating a user's account data can include receiving an HTTP POST command including an identifier of a portion of a user account and a value for updating the portion. The POST message can be received by the content receiver 202, which can separate the message and content portions.

As described above, a request or command identifier can be provided by the message handler 406 to the request router 414, which can identify, based on at least the request identifier, a command handler 206 configured to process the request, e.g., to update the identified user's account. The command handler 206 can provide the received message's payload to the data modeler component 204 supporting a schema for account information. The data modeler component 204 and/or the command handler 206 can identify the portion of the account information based on the schema, and update an area of storage allocated for the value associated with the account portion in the data store 416.

The resource can be included in the request, in a response to a request, in a notification message associated with a subscription, and/or in an asynchronous unsolicited message based on a detected event such as a remote procedure call from another node One or more command handlers 206 can be provided by the content/service provider 400 to process requests from client nodes 502, 602. A command handler 206 can be external to a content/service provider 400, included in a content/service provider 400, and/or be the content service provider 400.

When metadata associated with an accessed resource is identified, the data modeler component 204 and/or a widget handler, in response to receiving user input from a user, an event and/or an indication received from another component in the execution environment 402, can be configured to invoke the command handler 206 configured to generate a message identifying the resource, the metadata, and the identified schema of the metadata.

Whether in the browser 300 or the content/service provider 400, the command handler 206 can be configured to generate one or more messages identifying the resource, the metadata, and the schema of the metadata. The generated message can include at least a portion of the metadata and/or an identifier of the metadata, such as a URL for accessing the metadata, at least a portion of the resource and/or an identifier of the resource, and the schema of the metadata and/or an identifier of the schema. A variety of message formats and protocols can be suitable for the message.

In one embodiment, the identified metadata can be identified via a reference to the metadata in the accessed resource. Alternatively or additionally, the identified metadata can be the metadata included in and/or received along with the accessed resource. In one embodiment when an identifier of the metadata is not included in or along with the accessed resource, such an identifier can be generated based on the metadata, the resource and/or the schema.

For example, in one embodiment, a Uniform Resource Identifier (URI), such as a Uniform Resource Locator (URL) or a Uniform Resource Name (URN), can be generated for metadata when the metadata is included in the accessed resource. The URI can be based on an identifier, such as a URL, of the resource. For instance, the URL of the resource and an anchor identifying a location of at least a portion of the metadata can be detected in the resource and/or generated based on the resource.

In another embodiment, a URI template can be configured or otherwise provided for generating the URI for the metadata. The template can generate the URI for the metadata based on an identifier, such as a URL, of the schema of the metadata. For example, a “meta” scheme providing a schema for a URI for identifying metadata can be defined in the following exemplary manner:

meta://schemaID/[metadataID][?resource=resourceID]

As illustrated, the URI begins with a “meta” scheme identifier followed by a “://” prior to a domain portion of the URI. The domain portion of the URI includes an identifier of the schema of the metadata. The domain portion is followed by an optional path portion. In the example above, the optional path portion is a “metadataID”. The metadataID can be any identifier that uniquely identifies the metadata within the domain identified. The metadataID can be generated by a node accessing the resource, such as the client node 502, 602, by a content/service provider node 504, 604, by a metadata repository service node (MRN) 508, and/or by any other node hosting a service for allocating and/or generating metadataID's suitable for identifying metadata within a given domain of the “meta” scheme. In one embodiment, the metadataID can be a URL for accessing the metadata.

According to one embodiment, the “meta” scheme can also provide an optional query portion indicated by a ‘?’. The query portion can be message specific and is not restricted to the “resource=resourceID” keyword pair shown. A “resource=resourceID” pair can be included in a message for performing an operation on an association between a resource and a metadata instance of the resource. In one embodiment, URI's in the “meta” scheme can identify an association between metadata and a resource. Through an association between the metadata and the schema of the metadata, the schema can be implicitly or explicitly included in the association.

The metadata URI described above can identify the schema, the metadata and/or the resource and can be included in the message generated by the command handler 206 in one embodiment. When the metadata identifier is unknown, the metadata itself and/or a reference, such as a temporary reference, to the metadata can be included in the message. An identifier of the metadata can be determined and/or generated by a receiver of the message, and the sender of the message can receive the metadata's identifier, for example, in a response message. While exemplary identifiers above, such as URIs, have been based on names from a naming domain, the identifier of a resource, metadata, and associated metadata schema can also be based on a network address or any suitable naming system that can be segmented into domains.

Referring again to FIG. 1 in block 106, once generated, the message is sent to a metadata repository service configured to maintain a metadata association between the identified metadata and the resource. A system for managing metadata associated with a resource includes means for sending the message to a metadata repository service configured to maintain a metadata association between the identified metadata and the resource. For example, FIG. 2 illustrates a message formatter component 208 configured to send the message to a metadata repository service configured to maintain a metadata association between the identified metadata and the resource.

According to an exemplary embodiment, the metadata repository service (MRS) represents a “metadata domain” of the association between the metadata and the resource, and can be based on an identifying characteristic of metadata. For example, the metadata domain can be based on a metadata schema, a resource, and/or an instance of metadata. In addition, the metadata domain can be based on a location, a resource owner, and/or any other suitable attribute or identifier. The MRS representing the metadata domain can be configured to store the metadata and/or a reference to the metadata, and the resource and/or a reference to the resource.

In one embodiment, the message formatter component 208 can be configured with an identifier, e.g., a URL, for accessing the MRS. Alternatively or additionally, the message formatter component 208 can be configured to retrieve an identifier for accessing the MRS from configuration data of the sending node, e.g., the client node 502, 602. In other embodiments, the identifier for accessing the MRS can be received from user input, received over a network from a management server, such as a DHCP server, and/or packaged with the sending application. Alternatively, the identifier for accessing the MRS can be received along with the resource and/or when the metadata is identified. In another alternative, at least a portion of the identifier for accessing the MRS can be generated based on a configured template, an identifier of a schema of the metadata, an identifier of a resource, and/or an identifier of the metadata.

In one embodiment, the identifier for accessing the MRS can be the URL of a metadata repository node (MRN) hosting the MRS. In this embodiment, the message formatter component 208 can be configured to send the message to the MRN hosting the MRS, where the message can include the URL as a destination address for the message.

In one embodiment, the MRS can be a centralized service hosted by one of a plurality of MRNs forming an MDRS 510, as illustrated in FIG. 5. In this embodiment, each of the MRNs 508, 512, 514 can host one or more MRS's representing various metadata domains. In one embodiment, the identifier for accessing the MRS can be a URL of a first MRN 508 in the MDRS 510, which can be a default MRN for the client node 502. When the default MRN 508 does not host the MRS representing the metadata domain of the association between the metadata and the resource, the MRN 508 can be configured to determine another MRN, e.g., a second MRN 512, in the MDRS 510 that hosts the MRS representing the metadata domain for the metadata association. In this case, the first MRN 508 can be configured to route the message to the second MRN 512 hosting the MRS representing the metadata domain of the association between the metadata and the resource.

In another embodiment illustrated in FIG. 6, an MRS can be hosted by an MRN, e.g., a first MRN 608, included in a distributed collection of MRNs 612, 614 representing various metadata domains. In this embodiment, the identifier for accessing the MRS can be a URL of a network directory service, such as a resolution service node 616, configured to provide an identifier for the MRN 608 hosting the MRS in response to receiving a query for locating the MRS.

In one embodiment, a message formatter component 208 in a sending node, e.g., client node 602, can be configured to provide association information to an MDRS resolver 318, 418, which can be configured to generate or otherwise determine the identifier for accessing a MRN hosting the MRS, as described above. For example, in one embodiment, a message formatter component 208 and/or an MDRS resolver 318, 418, in a client node 602 can send a query message 660 to a resolution service node 616 to determine an identifier for the MRN hosting the MRS representing the metadata domain. The query can include a service type identifying an MRS type and/or a domain identifier identifying the metadata domain for the association described below. Based on the query, the resolution service node 616 can identify the MRN hosting the MRS, and send an identifier of the MRN, e.g., the first MRN 608, in a response message 665 to the client node 602. When received by the client node 602, the message formatter component 208 can use the MRN identifier to address a message to the MRN 608 hosting the MRS representing the metadata domain of the association between the metadata and the resource.

According to one embodiment, the resolution service node (RSN) 616 can be included in a resolution system including one or more resolution service nodes each representing a domain with at least one RSN representing the domain identified in the query. The RSN 616 representing the domain identified in the query can be configured to maintain a service record storing an identifier of an MRN, e.g., a second MRN 612, representing a second metadata domain of associations between metadata and resources and another MRN, e.g., a third MRN 614, representing a third metadata domain of such associations.

As noted above, the query message 660 from the sending node, e.g., client node 602, can include a service type identifying an MRS type, which then can be used to identify the MRN hosting the MRS. Alternatively or additionally, the query message 660 can include a domain identifier identifying the metadata domain for the association. In one embodiment, the domain identifier can be based on the metadata, the resource and/or the schema, and can be used by the resolution service node 616 and/or an MRN, e.g., first MRN 508, to determine the identifier of the MRN hosting the MRS.

According to one embodiment, the domain identifier can be a URI generated by a URI generator 320, 420 in the browser 300 or in the content/service provider service 400. The URI generator 320, 420 can be configured, in one embodiment, to generate a URN based on a schema for a URN scheme similar to the exemplary “meta” scheme described above. The URN can be a URL or other identifier based on one or more of the URL of the metadata, the URL of the schema, and/or the URL of the resource. For example, a URL of the schema can be used as a URN for identifying an MRN hosting the MRS for maintaining the association.

The URI generator 320, 420 can be invoked by the command handler 206 and/or can be invoked by the message formatter component 208, the MDRS resolver 418, MDRS protocol layer 412, and/or any other component configured to generate a domain identifier for identifying the metadata domain for the association. An example below illustrates a schema for URNs based on the “meta” scheme described above.
meta:resolver=“%variable1%”//schemaID/[metadataID]?resource=“resourceID”? command=“add”

As described earlier, the URI begins with the “meta” scheme identifier and a domain portion of the URI. In addition, the URI includes a “resolver” scheme modifier that comprises a “%variable1%” portion that can be provided by the MDRS resolver 318, 418 identifying a node configured to return a URL corresponding to the meta scheme URN, or to identify another node that may be able to resolve the meta scheme URN to a URL. For example, a resolver node URL can be provided to the MDRS 318, 418 via a DHCP server for providing a value for the “%variable1%” portion of the resolver scheme modifier. In one embodiment, one or more operation commands can be processed with respect to the metadata and/or resource by the identified MRS, as illustrated by the “command=add” portion supported by the exemplary “meta” scheme.

For any detected instance of metadata, one or more URNs can be determined for its various portions based on a schema ID associated with each respective portion of the metadata. Each portion can be associated with a respective metadata domain of an MDRS 510 for storing an association between the portion and an associated resource. For example, a detecting program can be configured with a “resolving” URL, as described above, providing each schema ID of each respective portion of the metadata as the “%variable1%” portion for sending to a URN resolver configured to return a URL of an MRS. The message identifying the metadata, the resource and the identified schema can include the domain identifier and can be sent to the MRS using the returned URL as a destination address.

In one embodiment, the message formatter component 208 can receive the message generated by the command handler 206 operating in the browser 300 or operating in the content/service provider 400. The message formatter 208 can be configured to format the message for sending to an MRN, e.g., first MRN 508, 608, hosting the MRS according to a particular protocol compatible with the MRN 508, 608 or MDRS 510 via the network 506, 606. The message formatter 208 in the browser 300 can provide the message to a content manager 322, which can be configured to provide the message to a corresponding protocol layer matching the format of the message sent by the message formatter 208. For example, the message can be sent via the HTTP protocol layer 310, 410, the MDRS protocol layer 312, 412, and/or a protocol supported by the network subsystem 308, 408, such as TCP or UDP. The protocols listed are exemplary and not exhaustive.

According to one embodiment, the message can identify a metadata domain such as at least a portion of the domain portion of the meta scheme URN described above. When the metadata domain identified is included in the metadata domain represented by the MRS hosted by the receiving MDN 508, 608, an association between the metadata and the identified resource can be stored by the MRS. When the identified metadata domain is not in the metadata domain represented by the MRS hosted by the receiving MDN 508, 608, the MRS can be configured to send the message identifying the resource, the metadata, and optionally the schema to another MRN, e.g., a second MRN 512, 612, that hosts an MRS representing the metadata domain including the metadata association.

According to one embodiment, a schema can include at least a portion of another schema. In XML, this is made possible through XML namespaces. When the message identifies a schema that includes at least portion of another schema, the other schema can be identified. For example, a first schema can be included in the message or in the accessed resource. The identifier of a second schema can be specified in the first schema. In such a case, an MRN, such as the first MRN 508 can store an association between a portion of the metadata, the resource, and the schema portion having a metadata domain included in its identifier that is represented by the first MRN 508.

A second portion of the metadata associated with the second schema included in the first schema can be identified along with the resource and the second schema in a message routed via the MDRS 510 to a second MRN 512. The second MRN 512 represents a second metadata domain including at least a portion of the second domain identified in the identifier of the second schema. The second MRN 512 can create, update, or otherwise store an association between the second portion of the metadata, the resource, and at least a portion of the second schema. Alternatively, the MRN representing a metadata domain including at least a portion of a domain identified in the schema identifier can create, update, or otherwise store an association between all the metadata, the resource, and the schema.

Messages in the MDRS 510 can be routed based on a metadata domain identified in the identified schema. For example, if a schema has a URL, http://my.site.org/meta/schema3, the message can be routed based on “my.site.org” to an MRN representing the metadata domain “my.site.org” or routed to an MRN representing a metadata domain including the domain “site.org.”

In a further alternative, the URI of the schema can be received by a resolver that is configured to generate a URL or URN of a scheme that is different than the scheme of the URI of the metadata. For example, the URL http://my.site.org/meta/schema can be transformed into a URN having a “meta” scheme, meta://my.site.org/meta/schema, where “my.site.org” is not a host identifier of an MRN for storing an association identifying the schema.

According to one embodiment, an MRS representing a metadata domain of a schema can allocate storage having a format compatible with the metadata as defined by the schema of the metadata. Accordingly, metadata specified according to an RDF based schema can be stored in an RDF data repository and/or can be translated to another schema, such as an SQL compatible schema for storing when the metadata itself is stored. Alternatively and additionally, the URL of the metadata can be stored in the MRS for accessing the metadata as requested. Similarly, the schema and/or the resource can be stored as a copy of the original or as a reference to the original.

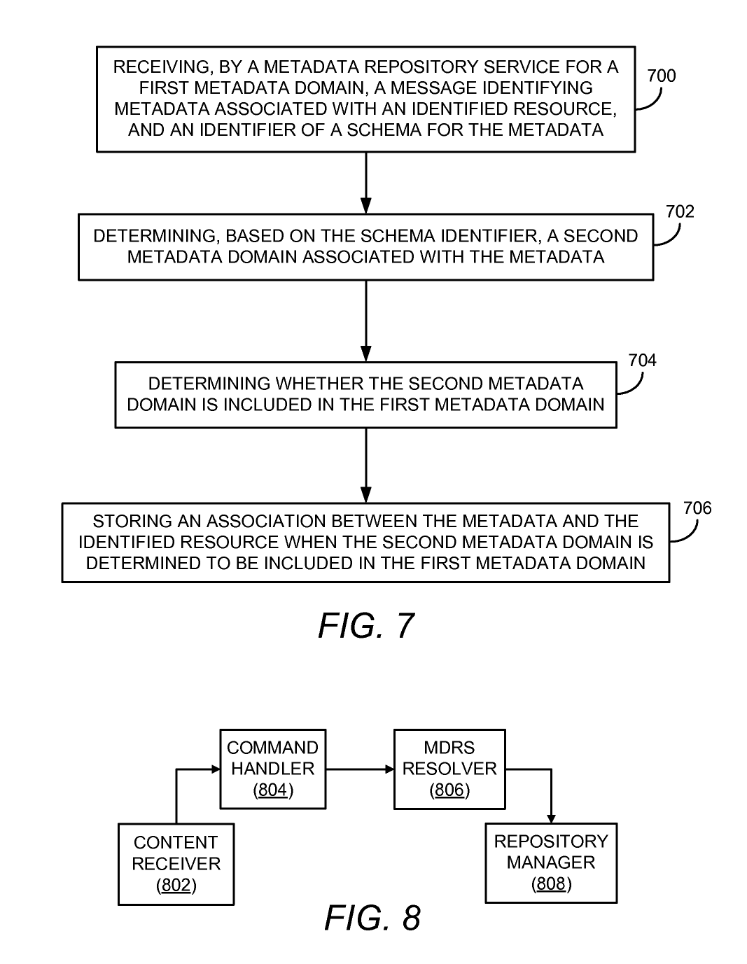

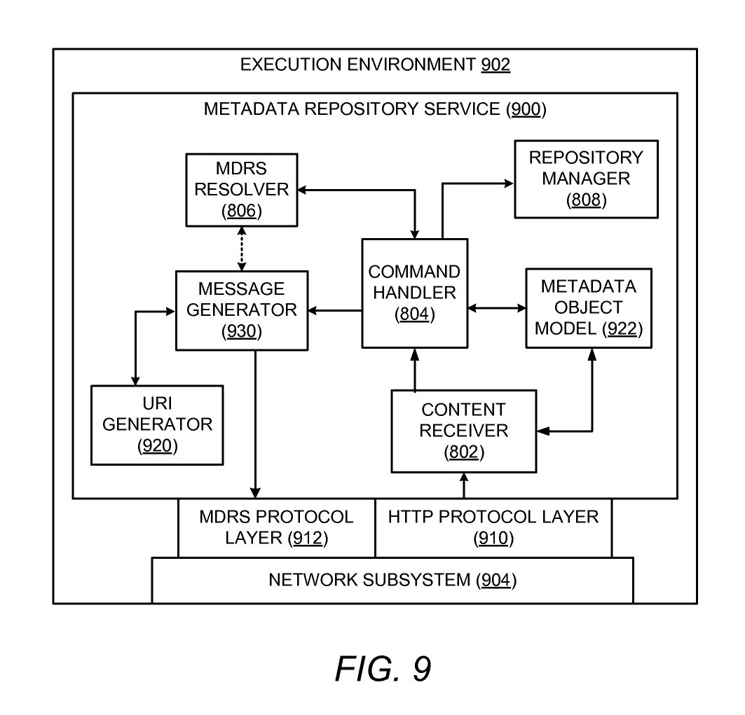

FIG. 7 is a flow diagram illustrating a method for managing metadata associated with a resource according to another aspect of the subject matter described herein. In particular, the method is from the perspective of the metadata repository service (MRS). FIGS. 8 and 9 are block diagrams illustrating systems for managing metadata associated with a resource according to embodiments of the subject matter described herein. In particular, FIG. 8 illustrates an arrangement of components configured for managing metadata associated with a resource, while FIG. 9 illustrates the components of FIG. 8 and/or their analogs adapted for operation in an execution environment provided by one or more nodes for managing metadata associated with a resource. The method illustrated in FIG. 7 can be carried out by, for example, at least some of the components in each of the exemplary arrangements of components illustrated in FIGS. 8 and 9. For example, Illustrated in FIG. 9 is an MRS 900 including the components illustrated in FIG. 8 adapted for operating in an execution environment 902 provided by a node such as the MRN 508, 608.

Referring to FIG. 7 in block 700, a message identifying metadata associated with an identified resource, and an identifier of a schema of the metadata is received by a metadata repository service for a first metadata domain. According to an exemplary embodiment, a system for managing metadata associated with a resource includes means for receiving, by a metadata repository service for a first metadata domain, a message identifying metadata associated with an identified resource, and an identifier of a schema for the metadata. For example, FIG. 8 illustrates a content receiver 802 configured to receive a message identifying metadata associated with an identified resource, and an identifier of a schema for the metadata.

According to an exemplary embodiment, the message can be received by a content receiver 802 included in an MRS 900 operating in an execution environment 902 provided by an MRN 508, 608. The MRS 900 represents a first metadata domain of associations between metadata and resources. In one embodiment, the message can be received from the client node 502, 602, as illustrated by the message 570, 670, or from the content 504 or service 604 provider nodes. The message can be transmitted from the sending node via the network 506, 606 and received by the content receiver 802 via the network subsystem 904 and optionally a higher layer protocol, such as an MDRS protocol layer 912 and/or an HTTP protocol layer 910.

In one embodiment, the received message is the same message generated and sent according to the method described in FIG. 1. Accordingly, the message can include at least a portion of the metadata and/or an identifier of the metadata, at least a portion of the resource and/or an identifier of the resource, and the schema of the metadata and/or an identifier of the schema. The content receiver 802 can be configured to route the message based on a command or request detected in the message. One or more command handlers 804 can be included in the MRS 900 for performing various commands and/or requests identified in the received message.

Referring again to FIG. 7 in block 702, a second metadata domain associated with the metadata is determined based on the identified schema identifier in the received message. According to an exemplary embodiment, a system for managing metadata associated with a resource includes means for determining, based on the schema identifier, a second metadata domain associated with the metadata. For example, FIG. 8 illustrates a command handler 804 configured to determine a second metadata domain associated with the metadata based on the schema identifier.

In one embodiment, the MRS 900 can provide one or more command handlers 804 configured to process one or more commands. When the content receiver 802 receives the message, it can determine that the message is associated with a request for creating, updating, and/or otherwise storing metadata association information. The message can be provided to one or more command handlers 804 configured to perform and/or provide for performing the indicate request(s). According to one embodiment, the command handler 804 can process the message and determine, based on the identifier of the schema for the metadata, a second metadata domain associated with the metadata.

For example, as described above, the received message can include a URI defined according to a “meta” scheme for identifying the metadata and/or the metadata domain. The URI can be based on an identifier, such as a URL, of the schema of the metadata. As described above, the URI can begin with the “meta” scheme identifier followed by a “://” prior to a domain portion of the URI. In one embodiment, the domain portion of the URI can include a URL of the schema of the metadata, from which the command handler 804 can determine the second metadata domain associated with the metadata.

In another embodiment, the command handler 804 can determine the second metadata domain associated with the metadata by detecting, and/or receiving from the content receiver 802, an identifier of the second metadata domain in the schema identifier. In this case, the command handler 804 can identify the second metadata domain using the corresponding identifier. For example, in one embodiment, the command handler 804 can pass the detected identifier of the second metadata domain to an MDRS resolver component 806, which can be configured to generate or otherwise determine the second metadata domain based on the received identifier. In one embodiment, the MDRS resolver component 806 can send a query message (not shown) including the identifier to the resolution service node 616 to determine the second metadata domain associated with the identifier.

Referring again to FIG. 7, once the second metadata domain is determined, the method continues in block 704 by determining whether the second metadata domain is included in the first metadata domain. According to an exemplary embodiment, a system for managing metadata associated with a resource includes means for determining whether the second metadata domain is included in the first metadata domain. For example, FIG. 8 illustrates a MDRS resolver component 806 configured to determine whether the second metadata domain is included in the first metadata domain.

According to one embodiment, the command handler 804 in response to determining the second metadata domain can provide an identifier of the second metadata domain to the MDRS resolver component 806. The MDRS resolver component 806 can be configured to determine whether the second metadata domain is included in the first metadata domain by, for example, performing a matching algorithm and/or performing a lookup in a table or other storage location for locating a matching entry. For instance, when the first metadata domain represented by the MRS 900 is “site.org” and the second metadata domain associated with the metadata is “my.site.org,” the base domain of the second metadata domain matches the first metadata domain, “site.org.” Accordingly, in this case, the second metadata domain would be determined to be included in the first metadata domain.

In one embodiment, when the second metadata domain is determined to be included in the first metadata domain, the MDRS resolver component 806 can provide an indication to the command handler 804 to this effect. Otherwise, the MDRS resolver component 806 can provide an indication to the command handler 804 that the second metadata domain is not included in the first metadata domain and/or can provide the negative indication to another component, such as a message generator 930 configured to process messages when the determined second metadata domain is not included in the first metadata domain represented by the MRS 900.

Referring again to FIG. 7 in block 706, when the second metadata domain is determined to be included in the first metadata domain, an association between the metadata and the identified resource is stored. According to an exemplary embodiment, a system for managing metadata associated with a resource includes means for storing an association between the metadata and the identified resource. For example, FIG. 8 illustrates a repository manager component 808 configured to store an association between the metadata and the identified resource when the second metadata domain is determined to be included in the first metadata domain.

According to an exemplary embodiment, when the command handler 804 receives the indication that the second metadata domain is included in the first metadata domain, the command handler 804 invokes the repository manager component 808 configured to store an association between the metadata and the resource. In one embodiment, the repository manager component 808 can store at least a portion of the metadata and/or a reference to the metadata, and/or a copy of the identified resource and/or a reference to the identified resource. In addition, the schema and/or schema identifier can be stored as well. In one embodiment, described above, the repository manager component 808 can be configured to allocate storage having a format compatible with the metadata as defined by the schema of the metadata. For example, metadata specified according to an RDF based schema can be stored in an RDF data repository and/or can be translated to another schema, such as an SQL compatible schema for storing when the metadata itself is stored.

In addition to storing the association when the command handler 804 receives the indication that the second metadata domain is included in the first metadata domain, the command handler 804 can also invoke the message generator 930 to generate an identifier for the association between the metadata and the identified resource. In one embodiment, message generator 930 can call a URI generator 920 to generate the identifier for the association, which can be based on the metadata, the schema, and/or the resource. As described above, the URI generator 920 can be configured, in one embodiment, to generate a URN based on a schema for a URN scheme similar to the exemplary “meta” scheme. The URN can be a URL or other identifier based on one or more of the URL of the metadata, the URL of the schema, and/or the URL of the resource. For example, a URL of the schema can be used as a URN for identifying the MRN hosting the MRS 900 for maintaining the association.

The identifier for the association can be provided back to the message generator 930, which can be configured to generate a response including the identifier and to send the response to the sending node, e.g., the client node 502, 602 or the content 504 or service 604 provider nodes. Alternatively or additionally, the identifier for the association can be stored in lieu of, or in addition to, the metadata and/or reference to the metadata, and/or the copy of the identified resource and/or the reference to the identified resource.

When the command handler 804 receives an indication that the second metadata domain is not included in the first metadata domain, the command handler 804 can discard the received message. Alternatively, the command handler 804 can invoke the message generator 930 to generate a second message based on the received message. In one embodiment, the second message can update the received message and/or it can be a new message. For example, the second message that is a new message can be a response indicating that the MRS 900 does not represent the second metadata domain and the response can be sent to the sending node. Alternatively or additionally, the second message can be an update of the received message and can be sent for routing to a second MRS for storing an association between the metadata and the identified resource.

According to an exemplary embodiment, when the second message is to be sent for routing to the second MRS, the message generator 930 is configured to determine a network address of a node configured to route the second message to the second MRS. In one embodiment, the message generator 930 can be configured with an identifier, e.g., a URL, for accessing the second MRS. In other embodiments, the message generator 930 can be configured to retrieve an identifier for accessing the second MRS from configuration data of the MRS 900. In other embodiments, the identifier for accessing the second MRS can be received with the message, over a network from a resolver service 616, and/or packaged with the sending application. In another alternative, at least a portion of the identifier for accessing the second MRS can be generated based on a configured template, an identifier of a schema of the metadata, an identifier of a resource, and/or an identifier of the metadata.

In one embodiment, the message generator 930 can invoke the MDRS resolver 806, which can be configured to generate or otherwise determine the identifier for accessing the second MRS, as described above. For example, in one embodiment, the MDRS resolver 806 can send a query to the resolution service node 616 to determine an identifier for a second MRN, e.g., 512, 612, hosting the second MRS representing the second metadata domain. The query can include a service type identifying an MRS type and/or the domain identifier described above. Based on the query, the resolution service node 616 can identify the second MRN 512, 612 hosting the second MRS, and return an identifier of the second MRN 512, 612 in a response message. The message generator 930 can use the identifier of the second MRN 512, 612 to route the second message to the second MRS.

It should be understood that the various system components (and means) defined by the claims and illustrated in the various block diagrams represent logical components that are configured to perform the functionality described herein. While at least one of these components are implemented at least partially as an electronic hardware component, and therefore constitutes a machine, the other components may be implemented in software, hardware, or a combination of the two. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function). Other components may be implemented in software, hardware, or a combination of the two. Moreover, some or all of these other components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions. At least one of these aspects defined by the claims is performed by an electronic hardware component. For example, it will be recognized that the various actions can be performed by specialized circuits or circuitry, by program instructions being executed by one or more processors, or by a combination of both. The description herein of any sequence of actions is not intended to imply that the specific order described for performing that sequence must be followed. All methods described herein can be performed in any suitable order unless otherwise indicated herein or otherwise clearly contradicted by context.

Moreover, the methods described herein can be embodied in executable instructions stored in a computer readable medium for use by or in connection with an instruction execution machine, apparatus, or device, such as a computer-based or processor-containing machine, apparatus, or device. As used here, a “computer-readable medium” can include one or more of any suitable media for storing the executable instructions of a computer program in one or more of an electronic, magnetic, optical, and electromagnetic, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), a Blu-ray™ disc; and the like.

The use of the terms “a” and “an” and “the” and similar referents in the context of describing the subject matter (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illuminate the subject matter and does not pose a limitation on the scope of the subject matter unless otherwise claimed. No language in the specification should be construed as indicating any non-claimed element as essential to the practice of the invention as claimed.

Preferred embodiments are described herein, including the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A method for managing metadata associated with a resource, the method comprising:
accessing a network resource;
identifying metadata associated with the resource in response to accessing the resource, the metadata specified according to an identified schema;
generating, in response to identifying the metadata, a message identifying the resource, the metadata, and the identified schema; and
sending the message to a metadata repository service configured to maintain a metadata association between the identified metadata and the resource,
wherein at least one of the preceding actions in performed on at least one electronic hardware component.

2. The method of claim 1 wherein accessing the network resource includes at least one of:
receiving the resource in a message, the message being at least one of a response to a request, a notification associated with a subscription, and an unsolicited asynchronous message; and
retrieving the resource from a local source.

3. The method of claim 1 wherein identifying metadata associated with the resource includes at least one of assembling a data model corresponding to the network resource, and dynamically processing the network resource as it is accessed.

4. The method of 1 wherein the identified metadata is at least one of included in the accessed resource, identified by a reference included in the accessed resource, in a message including at least a portion of the accessed resource, received in another message, and retrieved from another resource including at least one of a file in a data store and a record in a database.

5. The method of claim 1 wherein the generated message includes at least one of a portion of the metadata and an identifier of the metadata, at least one of a portion of the resource and an identifier of the resource, and at least one of the schema of the metadata and an identifier of the schema.

6. The method of claim 1 wherein the metadata repository service represents a metadata domain of the association between the metadata and the resource.

7. The method of claim 6 further comprising generating a domain identifier identifying the metadata domain and based on at least one of the metadata, the resource, and the schema.

8. The method of claim 7 wherein the domain identifier is a Uniform Resource Identifier (URI).

9. The method of claim 8 wherein the URI is a Uniform Resource Name including at least a portion of at least one of a Uniform Resource Locator (URL) of the resource, a URL of the metadata, and a URL of the schema.

10. The method of claim 7 wherein the generated message includes the domain identifier.

11. The method of claim 10 wherein sending the message to the metadata repository service includes determining a network address of a node configured to route the message to the metadata repository service representing the metadata domain based on the domain identifier, wherein the determined network address is at least one of provided in configuration data of a sending node, received with the accessed resource, received when the metadata is identified, received from a resolver service in response to a request identifying at least one of the metadata, the resource, and the identified schema, and generated based on identifiers of at least one of the metadata, the resource, and the identified schema.

12. The method of claim 11 wherein the determined network address is associated with a first node of a plurality of nodes forming a metadata repository system, wherein the first node is configured to route the generated message to the metadata repository service.

13. A method for managing metadata associated with a resource, the method comprising:
receiving, by a metadata repository service for a first metadata domain, a message identifying metadata associated with an identified resource, and an identifier of a schema for the metadata;
determining, based on the schema identifier, a second metadata domain associated with the metadata;
determining whether the second metadata domain is included in the first metadata domain; and
storing an association between the metadata and the identified resource when the second metadata domain is determined to be included in the first metadata domain,
wherein at least one of the preceding actions is performed on at least one electronic hardware component.

14. The method of claim 13 wherein the message includes at least one of a portion of the metadata and an identifier of the metadata, at least one of a portion of the resource and an identifier of the resource, and at least one of the schema of the metadata and an identifier of the schema.

15. The method of claim 14 wherein the identifier of the schema includes an identifier of the second metadata domain, and wherein determining the second metadata domain includes detecting in the schema identifier the identifier of the second metadata domain and using the identifier of the second metadata domain to identify the second metadata domain.

16. The method of claim 13 wherein when the second metadata domain is determined to be included in the first metadata domain, the method includes:
generating an identifier for the association between the metadata and the identified resource, wherein the identifier for the association is based on at least one of the metadata, the schema, and the resource.

17. The method of claim 16 wherein storing the association between the metadata and the identified resource includes storing the identifier for the association.

18. The method of claim 17 wherein storing the association between the metadata and the identified resource further includes storing at least one of at least a portion of the metadata and a reference to the metadata, and storing at least one of a copy of the identified resource and a reference to the identified resource.

19. The method of claim 13 wherein the metadata repository service represents a metadata domain of the association between the metadata and the resource.

20. The method of claim 13 wherein when the second metadata domain is determined not to be included in the first metadata domain, the method further comprises generating a second message based on the received message, and sending the second message for routing to a second metadata repository service for storing an association between the metadata and the identified resource.

21. The method of claim 20 wherein sending the second message to the second metadata repository service includes determining an address of a node configured to route the second message to the second metadata repository service, wherein the determined address is at least one of provided in configuration data of the sending metadata repository service, received with the message, received from a resolver service in response to a request identifying at least one of the metadata, the resource, and the identified schema, and generated based on identifiers of at least one of the metadata, the resource, and the identified schema.

22. A computer readable medium storing a computer program, executable by a machine, for managing metadata associated with a resource, the computer program including executable instructions for:
accessing a network resource;
identifying metadata associated with the resource in response to accessing the resource, the metadata specified according to an identified schema;
generating, in response to identifying the metadata, a message identifying the resource, the metadata, and the identified schema; and
sending the message to a metadata repository service configured to maintain a metadata association between the identified metadata and the resource.

23. A computer readable medium storing a computer program, executable by a machine, for managing metadata associated with a resource, the computer program including executable instructions for:
receiving, by a metadata repository service for a first metadata domain, a message identifying metadata associated with an identified resource, and an identifier of a schema for the metadata;
determining, based on the schema identifier, a second metadata domain associated with the metadata;
determining whether the second metadata domain is included in the first metadata domain; and
storing an association between the metadata and the identified resource when the second metadata domain is determined to be included in the first metadata domain.

24. A system for managing metadata associated with a resource, the system comprising:
means for accessing a network resource;
means for identifying metadata associated with the resource in response to accessing the resource, the metadata specified according to an identified schema;
means for generating, in response to identifying the metadata, a message identifying the resource, the metadata, and the identified schema; and
means for sending the message to a metadata repository service configured to maintain a metadata association between the identified metadata and the resource, wherein at least one of the means includes at least one electronic hardware component.

25. A system for managing metadata associated with a resource, the system comprising:
means for receiving, by a metadata repository service for a first metadata domain, a message identifying metadata associated with an identified resource, and an identifier of a schema for the metadata;
means for determining, based on the schema identifier, a second metadata domain associated with the metadata;
means for determining whether the second metadata domain is included in the first metadata domain; and
means for storing an association between the metadata and the identified resource when the second metadata domain is determined to be included in the first metadata domain,
wherein at least one of the means includes at least one electronic hardware component.

26. A system for managing metadata associated with a resource, the system comprising system components including:
a content receiver configured to access a network resource;
a data modeler component configured to identify metadata associated with the resource in response to accessing the resource, the metadata specified according to an identified schema;
a command handler configured to generate, in response to identifying the metadata, a message identifying the resource, the metadata, and the identified schema; and
a message formatter component configured to send the message to a metadata repository service configured to maintain a metadata association between the identified metadata and the resource,
wherein at least one of the system components includes at least one electronic hardware component.

27. The system of claim 26 wherein the identified metadata is at least one of included in the accessed resource, identified by a reference included in the accessed resource, in a message including at least a portion of the accessed resource, received in another message, and retrieved from another resource including at least one of a file in a data store and a record in a database.

28. The system of claim 26 wherein the generated message includes at least one of a portion of the metadata and an identifier of the metadata, at least one of a portion of the resource and an identifier of the resource, and at least one of the schema of the metadata and an identifier of the schema.

29. The system of claim 26 wherein the metadata repository service represents a metadata domain of the association between the metadata and the resource.

30. The system of claim 29 wherein the command handler is configured to generate a domain identifier identifying the metadata domain and based on at least one of the metadata, the resource, and the schema.

31. The system of claim 30 wherein the domain identifier is a Uniform Resource Identifier (URI).

32. The system of claim 31 wherein the URI is a Uniform Resource Name (URN) including at least a portion of at least one of a Uniform Resource Locator (URL) of the resource, a URL of the metadata, and a URL of the schema.

33. The system of claim 30 wherein the generated message includes the domain identifier.

34. The system of claim 33 wherein the message formatter component is configured to determine a network address of a node configured to route the message to the metadata repository service representing the metadata domain based on the domain identifier, wherein the determined network address is at least one of provided in configuration data of a sending node, received with the accessed resource, received when the metadata is identified, received from a resolver service in response to a request identifying at least one of the metadata, the resource, and the identified schema, and generated based on identifiers of at least one of the metadata, the resource, and the identified schema.

35. The system of claim 34 wherein the determined network address is associated with a first node of a plurality of nodes forming a metadata repository system, wherein the first node is configured to route the generated message to the metadata repository service.

36. A system for managing metadata associated with a resource, the system comprising system components including:
a content receiver in a metadata repository service for a first metadata domain configured to receive a message identifying of metadata associated with an identified resource, and an identifier of a schema for the metadata;
a command handler component configured to determine, based on the schema identifier, a second metadata domain associated with the metadata;
a resolver component configured to determine whether the second metadata domain is included in the first metadata domain; and
a repository manager component configured to store an association between the metadata and the identified resource when the second metadata domain is determined to be included in the first metadata domain,
wherein at least one of the system components includes at least one electronic hardware component.

37. The system of claim 36 wherein the message includes an identifier of the schema that includes an identifier of the second metadata domain, and wherein the command handler component is configured to detect in the schema identifier the identifier of the second metadata domain and use the identifier of the second metadata domain to identify the second metadata domain.

38. The system of claim 36 wherein the resolver component is configured to generate an identifier for the association between the metadata and the identified resource when the second metadata domain is determined to be included in the first metadata domain, wherein the identifier for the association is based on at least one of the metadata, the schema, and the resource.

39. The system of claim 38 wherein the repository manager component is configured to store the identifier for the association, store at least one of at least a portion of the metadata and a reference to the metadata, and store at least one of a copy of the identified resource and a reference to the identified resource.

40. The system of claim 36 wherein the metadata repository service represents a metadata domain of the association between the metadata and the resource.

41. The system of claim 36 further comprising a message generator component configured to generate a second message based on the received message, and to send the second message for routing to a second metadata repository service for storing an association between the metadata and the identified resource when the second metadata domain is determined not to be included in the first metadata domain.

42. The system of claim 41 wherein the message generator component is configured to determine an address of a node configured to route the second message to the second metadata repository service, wherein the determined address is at least one of provided in configuration data of the sending metadata repository service, received with the message, received from a resolver service in response to a request identifying at least one of the metadata, the resource, and the identified schema, and generated based on identifiers of at least one of the metadata, the resource, and the identified schema.
